(19) United States
(12) Patent Application Publication
(10) Pub. No.: US 2020/0353370 A1
(43) Pub. Date: Nov. 12, 2020

(54) SCOOTER HAVING THREE DIMENSIONAL CHARACTER

(71) Applicants: Snap Pop, Coto de Caza, CA (US); 1867361 Ontario Inc., Etobicoke (CA)

(72) Inventors: Amit SINGH, Coto de Caza, CA (US); Robert Douglas STEWART, Etobicoke (CA)

(21) Appl. No.: 16/961,433

(22) PCT Filed: Mar. 29, 2019
(86) PCT No.: PCT/US2019/025016

§ 371 Date: Jul. 10, 2020

Related U.S. Application Data
(60) Provisional application No. 62/744,717, filed on Oct. 12, 2018.

(51) Int. Cl. A63G 19/02; A63H 17/38; B62M 1/00; B62K 15/00; B62K 9/02

(52) U.S. Cl. CPC A63G 19/02; A63H 17/38; A63G 17/00; B62K 15/006; B62K 9/02; B62M 1/00

(57) ABSTRACT

Systems, devices, and methods for a scooter (100) having a front portion (108) and a deck (116) for a user to stand on; and a three-dimensional character (110) disposed on the front portion of the scooter, where the three-dimensional character creates a perspective of riding on or in the three-dimensional character for the user on the deck.

### CROSS-REFERENCE TO RELATED APPLICATION

This application claims the priority benefit of U.S. Provisional Patent Application Ser. No. 62/744,717 filed Oct. 12, 2018, incorporated herein by reference in its entirety

### FIELD OF ENDEAVOR

The invention relates to personal transporters, and more particularly to kick scooters.

### BACKGROUND

A kick scooter is a vehicle having a handlebar, deck, and wheels that is propelled by a rider. Kick scooters may have two, three, or more wheels to provide balance to the rider. Some kick scooters may be foldable to create a smaller form factor for transportation or storage. Kick scooters may be made from aluminum, steel, plastic, or the like.

### SUMMARY

In one embodiment, a system disclosed herein may include: a scooter having a front portion and a deck for a user to stand on; and a three-dimensional character disposed on the front portion of the scooter, where the three-dimensional character creates a perspective of riding on or in the three-dimensional character for the user on the deck.

In additional system embodiments, the three-dimensional character may be an animal, a vehicle, and/or a creature. In additional system embodiments, the scooter may further include: a right front wheel connected to a right of the front portion; a left front wheel connected to a left of the front portion; and a rear wheel connected to a rear of the deck. In some embodiments, the system may also include: a rear fender brake, where the rear fender brake may be disposed above the rear wheel, and where a deflection of the rear fender brake relative to the deck may cause a lower surface of the rear fender brake to contact an outer surface of the rear wheel. Additional system embodiments may include: a character item attached to the rear fender brake, where the character item may correspond to the three-dimensional character disposed on the front portion of the scooter. In additional system embodiments, the character item may be at least one of: a animal item, a vehicle item, and a creature item. In additional system embodiments, the character item may be a tail. In additional system embodiments, the three-dimensional character may be detachably attached to the front portion of the scooter.

Additional system embodiments may include: a lower steering column; and a deck connector, where the deck connector may connect the front portion of the scooter and the lower steering column to the deck. In additional system embodiments, the deck connector may be at least one of: a headtube, a downtube, and a gooseneck connector. In additional system embodiments, the deck connector may include a folding mechanism.

Additional system embodiments may include: an upper steering column; a clamp, where the lower steering column may be attached to the upper steering column via the clamp, and where the upper steering column is extendable relative to the lower steering column via the clamp; a handlebar attached at an end of the upper steering column distal from the clamp; one or more grips attached to the handlebar; and one or more additional character items attached to the handlebar, where the one or more additional character items may correspond to the three-dimensional character. In additional system embodiments, the three-dimensional character may further include: at least one poseable element, where the at least one poseable element may be moved from a first position to a second position, and where the at least one poseable element may be at least one of: an eye, an eyelid, a nose, an ear, a hair, a clothing item, a face shape, a body shape, a vehicle part, a door, a light, and a window.

In one embodiment, a method disclosed herein may include: attaching a first three-dimensional character to a character attachment of a front portion of a scooter; and attaching a first character item to a character item attachment proximate at least one of: the first three-dimensional character, a handlebar, and a rear fender brake. Additional method embodiments may include: moving one or more of: one or more poseable elements of the first three-dimensional character and the first character item relative to a deck of the scooter. Additional method embodiments may include: detaching the first three-dimensional character from the character attachment of the front portion of the scooter; and detaching the first character item from the character item attachment. Additional method embodiments may include: attaching a second three-dimensional character to the character attachment of the front portion of the scooter; and attaching a second character item to the character item attachment proximate at least one of: the second three-dimensional character, the handlebar, and the rear fender brake. Additional method embodiments may include: moving one or more of: one or more poseable elements of the second three-dimensional character and the second character item relative to the deck of the scooter.

In one embodiment, a scooter disclosed herein may include: a front portion; a deck for a user to stand on; a right front wheel connected to a right of the front portion; a left front wheel connected to a left of the front portion; a rear wheel connected to a rear of the deck; a lower steering column; a deck connector, where the deck connector may connect the front portion of the scooter and the lower steering column to the deck, and where the deck connector may be at least one of: a headtube, a downtube, and a gooseneck connector; an upper steering column; a clamp, where the lower steering column may be attached to the upper steering column via the clamp, and where the upper steering column may be extendable relative to the lower steering column via the clamp; a handlebar attached at an end of the upper steering column distal from the clamp; one or more grips attached to the handlebar; a rear fender brake, where the rear fender brake may be disposed above the rear wheel, and where a deflection of the rear fender brake relative to the deck may cause a lower surface of the rear fender brake to contact an outer surface of the rear wheel; a character item attached to the rear fender brake; and a three-dimensional character disposed on the front portion of the scooter, where the three-dimensional character creates a perspective of riding on or in the three-dimensional character for the user on the deck, where the three-dimensional character is at least one of: an animal, a vehicle, and a creature, and where the character item corresponds to the three-dimensional character disposed on the front portion of the scooter.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a perspective view of a scooter, according to one embodiment;

FIGS. 2A-2D depict perspective views of a poseable three-dimensional character, according to one embodiment;

FIG. 3 depicts a system for a scooter having swappable three-dimensional characters and character items, according to one embodiment;

FIG. 4A depicts the scooter of FIG. 3 having the first three-dimensional character and first character item attached, according to one embodiment;

FIG. 4B depicts the scooter of FIG. 3 having the second three-dimensional character and second character item attached, according to one embodiment;

FIG. 4C depicts the scooter of FIG. 4B having the second three-dimensional character moved relative to the deck of the scooter, according to one embodiment;

FIG. 5 shows a high-level block diagram of a scooter system, according to one embodiment;

FIG. 6 depicts a high-level flowchart of a method embodiment of detachably attaching elements of the scooter system, according to one embodiment;

FIG. 7 depicts a computing device utilizing augmented reality (AR) with the scooter, according to one embodiment;

FIG. 8 depicts a perspective view of a scooter having a fire truck three-dimensional character, according to one embodiment;

FIG. 9 depicts a perspective view of a scooter having a dragon three-dimensional character, according to one embodiment;

FIG. 10 depicts a perspective view of a scooter having a unicorn three-dimensional character, according to one embodiment; and

FIG. 11 depicts a perspective view of a scooter having a princess carriage three-dimensional character, according to one embodiment.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The present system allows for a scooter having a three-dimensional character. The character may be an animal, a vehicle, a creature, or the like. The three-dimensional character creates the feeling of riding on the character for the user. For example, a scooter with a unicorn character creates the feeling and visual effect for the user of the user riding a unicorn. In some embodiments, the characters may be swappable between different characters. In other embodiments, the characters may be poseable. In other embodiments, the characters may have one or more moveable features. In other embodiments, augmented reality (AR) may be used to interact with the characters.

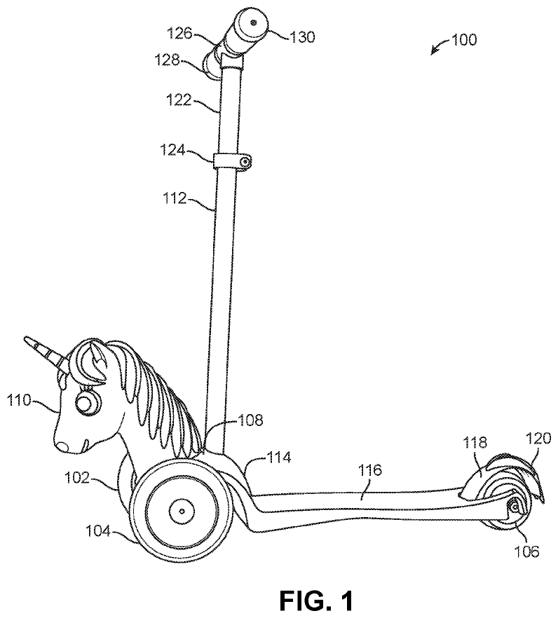

FIG. 1 depicts a perspective view of a scooter 100, according to one embodiment. The scooter 100 is shown with three wheels 102, 104, 106 so as to provide greater stability for the user, such as a younger rider. The scooter 100 may have a right front wheel 102, a left front wheel 104, and a rear wheel 106. In some embodiments, the scooter 100 may have any number of wheels, such as two wheels or four wheels. The front wheels 102, 104 may be mounted on either side of a front portion 108 of the scooter 100. A three-dimensional character 110 may be attached to the front portion 108 of the scooter 100. In some embodiments, the three-dimensional character 110 may be detachably attached to the front portion 108 of the scooter 100. The three-dimensional character 110 is depicted as a unicorn in this embodiment, but may be any animal, vehicle, creature, or object. In some embodiments, the three-dimensional character may be an animal head, such as a horse head to create the appearance for the user of riding a horse.

The front portion 108 of the scooter is connected to a lower steering column 112 and deck connector 114. The deck connector 114 connects the front portion 108 and lower steering column 112 to a deck 116. The deck connector 114 may be a headtube, downtube, or gooseneck connector. In some embodiments, the deck connector 114 may include a folding mechanism (not shown) to allow the scooter 100 to fold such that the rear wheel 106 is proximate the lower steering column 112 in a folded position.

The deck 116 provides a platform for the user to stand on while riding the scooter 100. The user may propel the scooter 100 by kicking with one leg on the ground and the other on the deck 116. After kicking, the user may glide by placing both feet on the deck 116 of the scooter 100.

A rear fender brake 118 may be disposed at a rear of the scooter 100 and above the rear wheel 106. Pressing down on the rear fender brake 118, such as by pressing down by a foot of the user, will cause the rear fender brake 118 to deflect relative to the deck 116 of the scooter 100. This deflection of the rear fender brake 118 will cause a lower surface of the rear fender brake 118 to contact an outer surface of the rear wheel 106. Friction from this contact will cause the scooter 100 to slow or stop. Friction from this contact may also prevent a stopped scooter 100 from moving, such as when a user is stopped at a hill or angled surface.

The scooter 100 may include one or more character items 120. The character item 120 is depicted as a unicorn tail in this embodiment, but may be any animal, vehicle, or creature item. In some embodiments, the character item 120 may be a tail. The character item 120 may correspond to the three-dimensional character 110. For example, the three-dimensional character 110 may be a horse head and the character item 120 may be a horse tail. A user on the scooter 100 would have the appearance of riding a horse when looking forward and of seeing a horse tail when looking back thereby creating an immersive experience of the user riding on the character. In some embodiments, the character item 120 may be detachably attached to the rear fender brake 118. The three-dimensional character 110 and the character item 120 may be detachably attached at various points of the scooter 100 to create a feeling and visual experience of that user riding on the character.

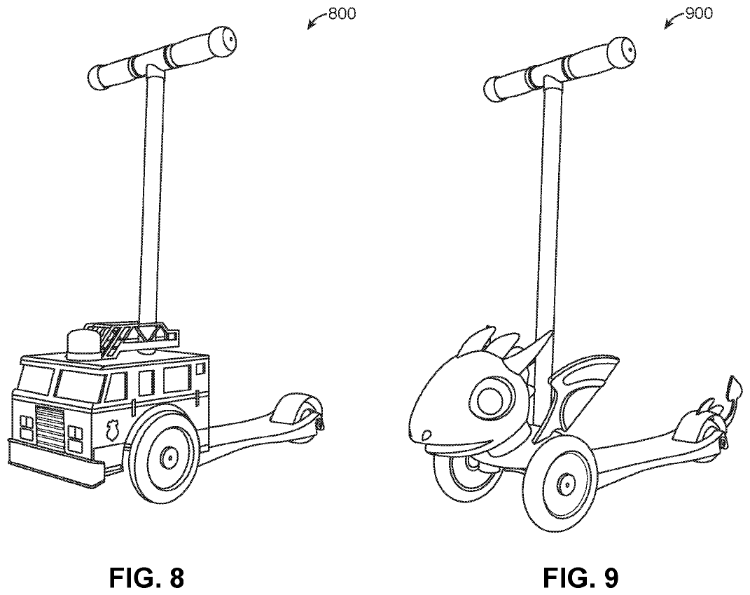

The lower steering column 112 may be attached to an upper steering column 122 via a clamp 124. In some embodiments, the clamp 124 may be a quick release clamp. The clamp 124 may be loosened to allow the upper steering column 122 to extend relative to the lower steering column 112. The clamp may then be tightened to secure the upper steering column 122 relative to the lower steering column 112 at a desired length. The upper steering column 122 may be adjusted relative to the lower steering column 112 to accommodate user's having different heights. In some embodiments, the scooter 100 may only have a single steering column and no adjustable height, as shown in FIGS. 8-11.

A handlebar 126 is attached at an end of the upper steering column 122 distal from the clamp 124. The handlebar may include one or more grips 128, 130. The grips 128, 130 may provide a user with improved handling of the scooter 100. In some embodiments, the grips 128, 130 may correspond to the three-dimensional character 110 and/or the character item 120. In some embodiments, the grips 128, 130 may be detachably attached and may be removed to match the detachably attached three-dimensional character 110 and/or the detachably attached character item 120. In some embodiments, the grips 128, 130 may include an additional character item, e.g., tassels that match the color of the unicorn. In other embodiments, the grips 128, 130 may match a color of the handlebar 126 and/or otherwise blend in so as not to distract from the three-dimensional character 110 and to draw attention to the three-dimensional character.

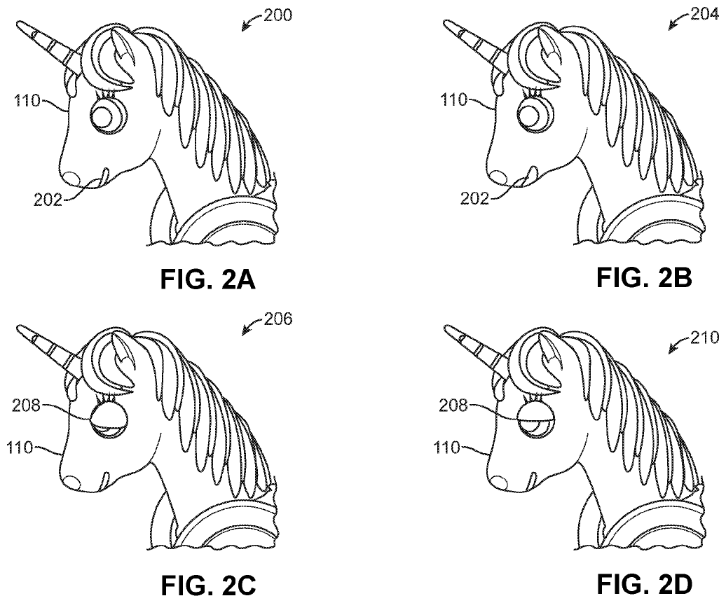

FIGS. 2A-2D depict perspective views of a poseable three-dimensional character 110, according to one embodiment. FIG. 2A depicts the three-dimensional character 110 having a first poseable element 202. The first poseable element 202 is depicted as a mouth, but may be any feature, including, but not limited to, eyes, noses, ears, hair, clothing, face shapes, body shapes, vehicle parts, doors, lights, windows, and the like. The first poseable element 202 may be in a first position 200. The first poseable element 202 may be varied, such as by creating a smile, frown, or the like, to create a second position 204. In another embodiment, a second poseable element 208 may be used. The second poseable element 208 is depicted as an eyelid, but may be any feature of the three-dimensional character 110. The second poseable element 208 may move from a third position 206 to a fourth position 210. By posing, moving, adjusting, rotating, actuating, or the like, each of the one or more poseable elements 202, 208, a user may create an overall position 200, 204, 206, 210 or expression of the character. Just as emojis may create a known expression, or feeling, the one or more poseable elements 202, 208 may be adjusted to create a desired expression for the three-dimensional character 110. For example, a user may pose their three-dimensional character 110 to look happy, grumpy, sleepy, or the like. The user may match the expression of the three-dimensional character 110 to their current emotion, role-play with the three-dimensional character 110, and/or take photos of the three-dimensional character 110 to share with others.

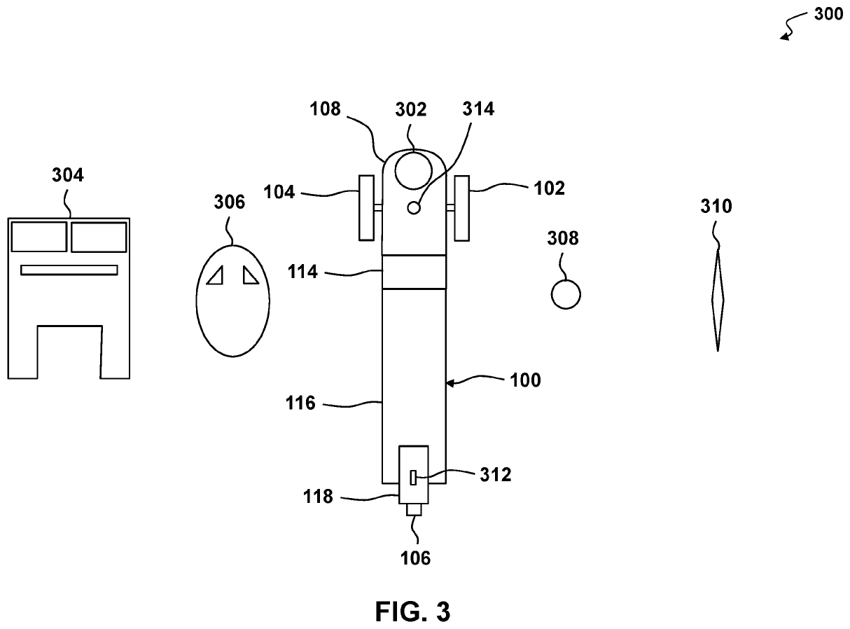

FIG. 3 depicts a system 300 for a scooter 100 having swappable three-dimensional characters 304, 306 and character items 308, 310, according to one embodiment. The front portion 108 of the scooter 100 may include a character attachment 302. The character attachment 302 may provide a detachable attachment to a first three-dimensional character 304 and/or a second three-dimensional character 306. The character attachment 302 may detachably attach to the three-dimensional characters 304, 306 via a friction fit, magnets, a threaded attachment, hook and loop fasteners, or the like. In some embodiments, the three-dimensional character 304, 306 may be fixedly attached to the front portion 108 of the scooter 100, such as via an adhesive, be molded as a part of the front portion 108, or the like. The first three-dimensional character 304 is depicted as a fire truck. The second three-dimensional character 306 is depicted as a lizard. The three-dimensional characters 304, 306 may be any vehicle, animal, creature, or the like. The three-dimensional characters 304, 306 may include a front portion of a character, such as a head, head and neck, front of a vehicle, or the like.

The system 300 may also include one or more character items 308, 310. The character items 308, 310 may correspond to the one or more three-dimensional characters 304, 306. A first character item 308 may be a red light that corresponds to the fire truck of the first three-dimensional character 304. A second character item 310 may be a diamond-shaped tail that corresponds to the lizard of the second three-dimensional character 306. The character items 308, 310 may detachably attach to a character item attachment 312 disposed on the rear fender brake 118. In other embodiments, the character items 308, 310 may be attached proximate the three-dimensional character 304, 306, the front portion 108 of the scooter 100, the deck 116 of the scooter 100, and/or the handlebar (126, FIG. 1). The character items 308, 310 may detachably attach to the character item attachment 312 via a friction fit, magnets, a threaded attachment, hook and loop fasteners, or the like. In some embodiments, the character item 308, 310 may be fixedly attached to scooter 100, such as via an adhesive, being molded as a part of the rear fender brake 118, or the like. In some embodiment, a portion of the rear fender brake 118 may include the character item 308, 310. In other embodiments, the entire rear fender brake 118 may be a character item 308, 310. In some embodiments, the three-dimensional characters 304, 306 may not be detachable and may form a front of the scooter 100. In some embodiments, the character items 308, 310 may not be detachable and may form a part of the scooter 100.

The lower steering column (112, FIG. 1) may be connected through an aperture 314 in the front portion 108 of the scooter 100. The scooter 100 may be turned by rotation of handlebars (126, FIG. 1), an angling of the lower steering column (112, FIG. 1), an angling of the deck 116, or the like.

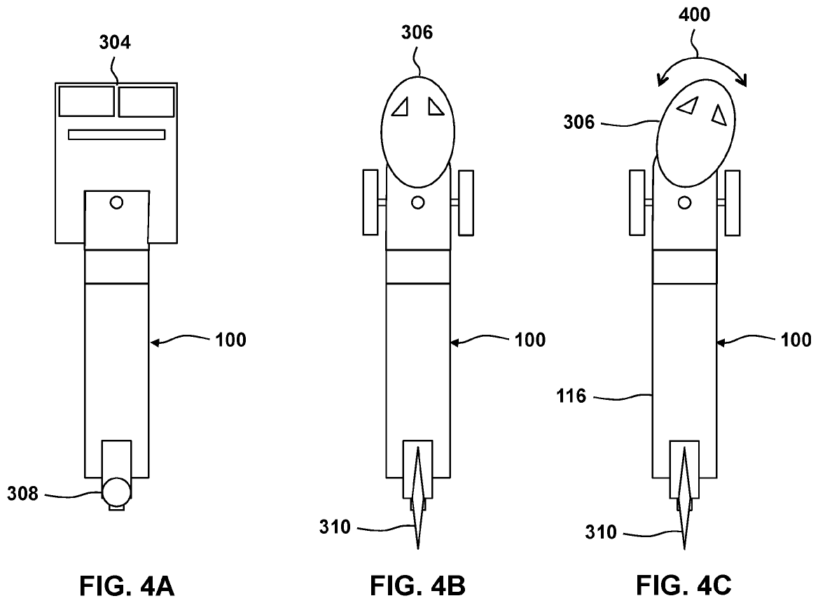

FIG. 4A depicts the scooter 100 of FIG. 3 having the first three-dimensional character 304 and first character item 308 attached, according to one embodiment. FIG. 4B depicts the scooter 100 of FIG. 3 having the second three-dimensional character 306 and second character item 310 attached, according to one embodiment. FIG. 4C depicts the scooter of FIG. 4B having the second three-dimensional character 306 moved 400 relative to the deck 116 of the scooter 100, according to one embodiment. In some embodiments, the three-dimensional character 306 may be moved 400, rotated, pivoted, or the like relative to the deck 116 of the scooter. In some embodiments, the three-dimensional character may rotate based on the movement of the scooter. For example, the three-dimensional character 306 may move 400 to the right when the scooter is making a right turn. This creates a sense of realism for the user on the scooter 100 as the three-dimensional character 306 is reacting based on the movements of the scooter 100. In other embodiments, the three-dimensional character 306 may move 400 while the scooter 100 is in motion. For example, wings on a dragon three-dimensional character may flap as the scooter is in motion. In other embodiments, the character item 310 may move as the scooter moves or turns. For example, a light character item may illuminate or flash during movement, turning, and/or braking. Movement of the one or more wheels may provide an energy source for movement of the one or more character items 310 and/or the three-dimensional characters 310, such as via a mechanical linkage or by charging one or more batteries. In other embodiments, one or more motors and/or batteries may be used to provide movement of the one or more character items 310 and/or the three-dimensional characters 310.

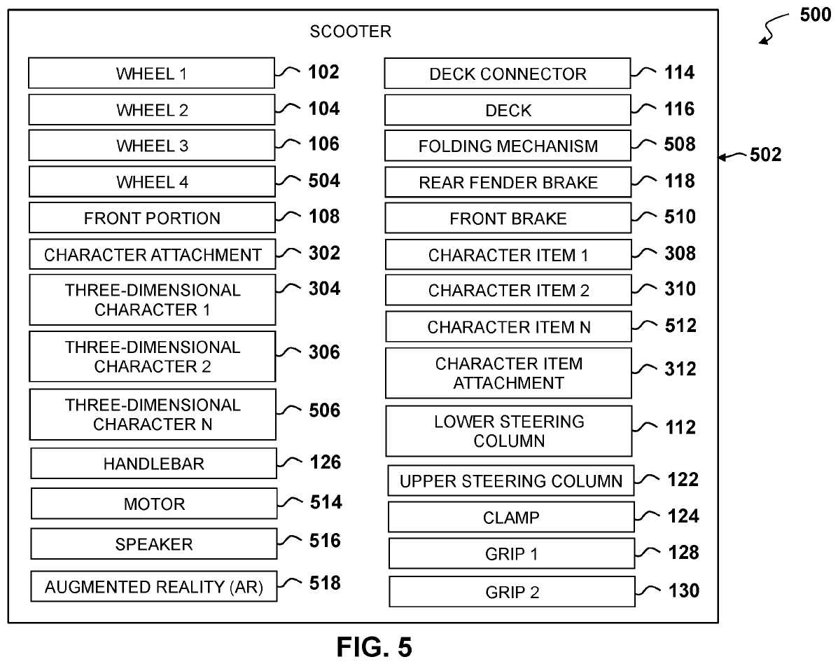

FIG. 5 shows a high-level block diagram of a scooter system 500, according to one embodiment. The scooter system 500 includes a scooter 502. The scooter 502 may have a first wheel 102, a second wheel 104, a third wheel 106, a fourth wheel 504, a front portion 108, a character attachment 302, a first three-dimensional character 304, a second three-dimensional character 306, additional three-dimensional characters 506, a handlebar 126, a motor 514, a speaker 516, an augmented reality (AR) component 518, a deck connector 114, a deck 116, a folding mechanism 508, a rear fender brake 118, a front brake 510, a first character item 308, a second character item 310, an additional character item 512, one or more character item attachments 312, a lower steering column 112, an upper steering column 122, a clamp 124, a first grip 128, and a second grip 130.

In some embodiments, the scooter 502 may include a fourth wheel 504. The scooter 502 may have two sets of wheels at the front and back for added stability. In some embodiments, the scooter 502 may have a motor 514. The motor 514 may be engaged via a mechanism, such as a throttle on the handlebars 126. The motor 514 may also provide additional power when the scooter 502 is manually used, such as by providing additional power on hills or the like. The motor may be powered by one or more batteries.

In some embodiments, the scooter 502 may include a speaker 516. The speaker 516 may play audio sounds that correspond to the three-dimensional character. For example, in an embodiment with a fire truck three-dimensional character, the speaker 516 may play fire truck noises. The speaker 516 may play noises when the scooter is in motion, when triggered by the user, when activated by a connected application, or the like. The speaker may be powered by one or more batteries.

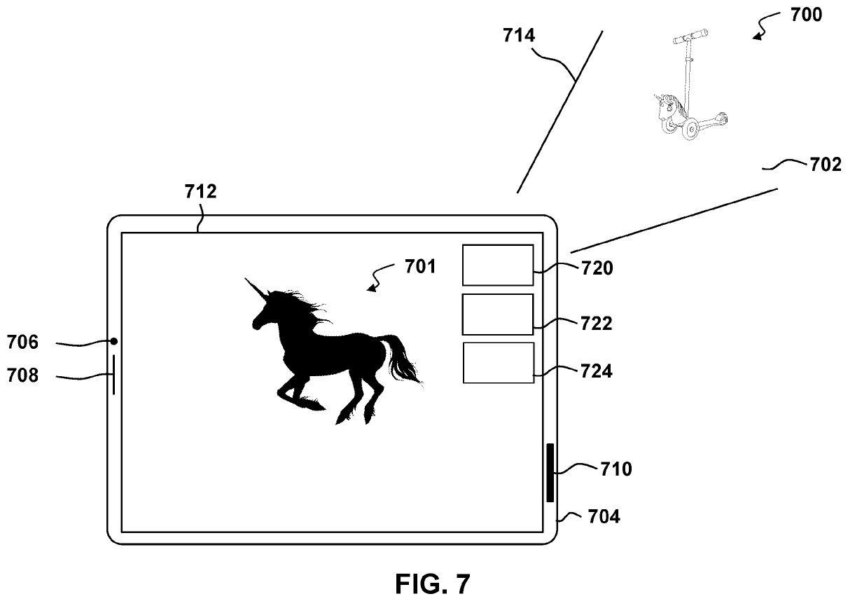

In some embodiments, the scooter 502 may utilize AR 518, such as shown in FIG. 7. An application on a user device, such as a smartphone, may show the three-dimensional character as the item itself. For example, a scooter 502 with a fire truck three-dimensional character may be displayed as a full-size, or smaller sized, fire truck on a display of the user device. In some embodiments, the user of the scooter 502 may be superimposed on the display, such as showing the user's face looking through the driver's side window of the fire truck or showing the user on top of the fire truck.

In some embodiments, the scooter 502 may utilize a folding mechanism 508. The folding mechanism 508 may allow the scooter 502 to collapse into a folded position for transport, storage, or the like. The folded position may allow the handlebar 126 to be disposed proximate the rear fender brake 118.

In some embodiments, the scooter 502 may include one or more front brakes 510. The front brake 510 may provide additional stopping power in addition to, or in place of, the rear fender brake 118. The front brake 510 may be engaged by a handle attached to the handlebars 126 in one embodiment.

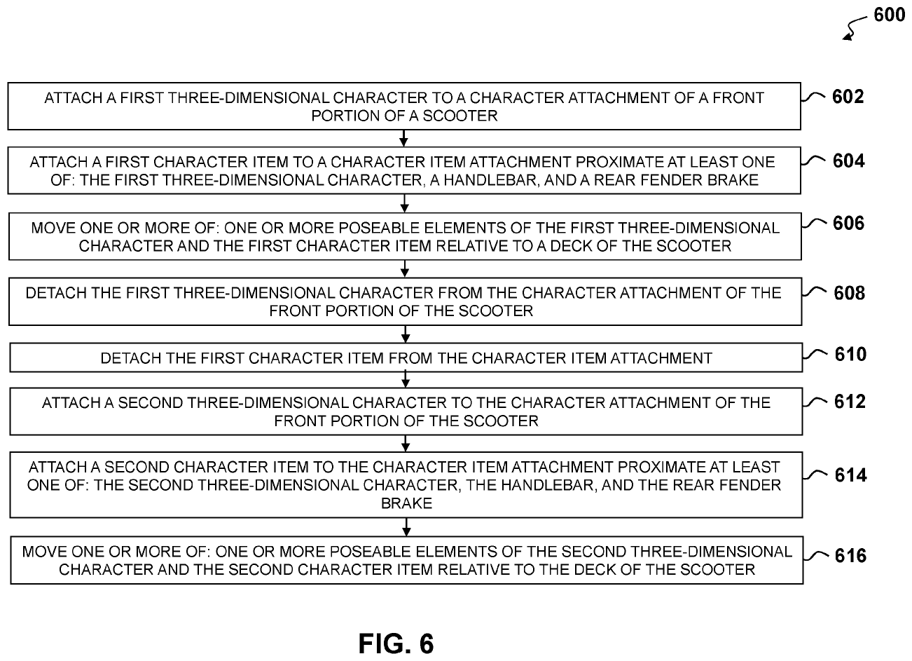

FIG. 6 depicts a high-level flowchart of a method embodiment 600 of detachably attaching elements of the scooter system, according to one embodiment. The method 600 may include attaching a first three-dimensional character to a character attachment of a front portion of a scooter (step 602). The method 600 may then include attaching a first character item to a character item attachment proximate at least one of: the first three-dimensional character, a handlebar, and a rear fender brake (step 604). The method may then include moving one or more of: one or more poseable elements of the first three-dimensional character and the first character item relative to a deck of the scooter (step 606). The method 600 may then include detaching the first three-dimensional character from the character attachment of the front portion of the scooter (step 608). The method 600 may then include detaching the first character item from the character item attachment (step 610). The method may then include attaching a second three-dimensional character to the character attachment of the front portion of the scooter (step 612). The method 600 may then include attaching a second character item to the character item attachment proximate at least one of: the second three-dimensional character, the handlebar, and the rear fender brake (step 614). The method 600 may then include moving one or more of: one or more poseable elements of the second three-dimensional character and the second character item relative to the deck of the scooter (step 616).

FIG. 7 depicts a computing device utilizing augmented reality (AR) with the scooter 700, according to one embodiment. The scooter 700 may be placed on a surface 702, such as a sidewalk, road, or the ground. A computing device 704, such as a tablet, smartphone, laptop computer, desktop computer, glasses, or the like, having a processor with addressable memory may utilize AR with the scooter 700. The computing device 704 may include one or more cameras 706, microphones 708, speakers 710, and/or displays 712. A rear-facing camera (not shown) may have a field of view 714 that includes the scooter 700.

The device 704 display may show the scooter 700 as an embodiment 701 of the three-dimensional character of the scooter 700. For example, a scooter 700 with a unicorn as the three-dimensional element may be displayed as a two-dimensional or three-dimensional unicorn embodiment 701 on the display 712 of the device 704. One or more visual elements 720, 722, 724 may also be displayed on the device 704 display 712. The visual elements may include a button to complete an action, a link to share on social media, a purchase of additional content, an action of the displayed embodiment 701, and the like. The device 704 may also receive input from the one or more microphones 708, such as an audio command. The device 704 may also receive input from the one or more cameras 706, such as a facial recognition of a user or a user's expression from a front facing camera. The device 704 may also receive input from a gyroscope of the user based on a movement of the device 704 relative to ground or relative to the scooter 700. The device 704 may play video via the display 712 and/or audio via the one or more speakers 710, such as a visual and/or audio content relating to the scooter 700 three-dimensional character.

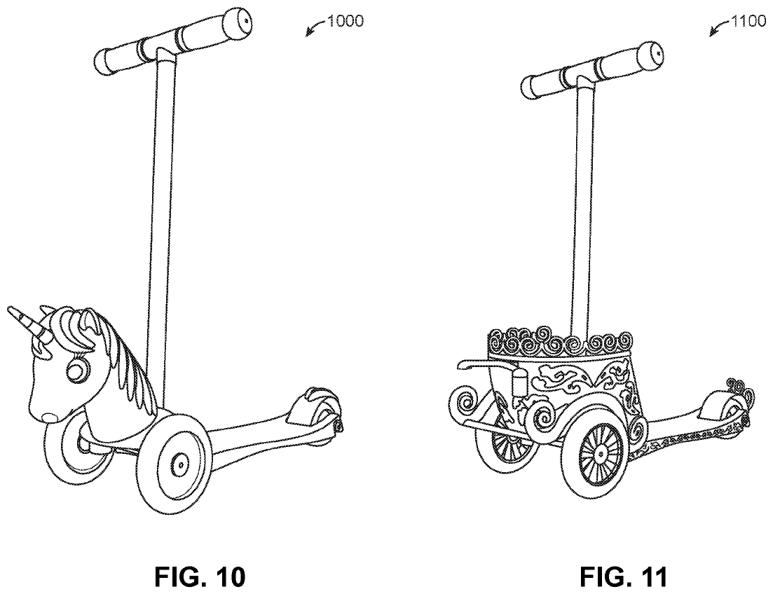

FIG. 8 depicts a perspective view of a scooter 800 having a fire truck three-dimensional character, according to one embodiment. FIG. 9 depicts a perspective view of a scooter 900 having a dragon three-dimensional character, according to one embodiment. FIG. 10 depicts a perspective view of a scooter 1000 having a unicorn three-dimensional character, according to one embodiment. FIG. 11 depicts a perspective view of a scooter 1100 having a princess carriage three-dimensional character, according to one embodiment. The scooters shown in FIGS. 8-11 are depicted as having a single steering column. The single steering column may reduce complexity, increase durability, and be set at a height comfortable for most users. In other embodiments, the scooters may have an adjustable steering column such that a height of the steering column relative to the deck may be adjusted, such as shown in FIG. 1. The three-dimensional character of the scooter may be any vehicle, animal, creature, or the like. In some embodiments, the three-dimensional character may be a head, face, or the like. The color the scooter deck and any other components may correspond to the three-dimensional character. For example, the fire truck scooter 800 may have a red deck corresponding to the color of the fire truck; the lizard scooter 900 may have a green deck corresponding to the color of the lizard; the unicorn scooter 1000 may have a multi-colored deck corresponding to the color of the mane on the unicorn; and the princess carriage scooter 1100 may have a deck with colors and features that continue from the princess carriage three-dimensional carriage.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1-21. (canceled)

22. A scooter comprising:
a deck for a user to stand on;
a deck connector connected to the deck forward of where the user stands;
a steering column attached to and extending vertically from the deck connector for the user to steer the scooter;
a front portion connected to the deck connector forward of the steering column; and
a three-dimensional character movably attached to and projecting forwardly from the front portion at a position forward of the steering column, and configured to move relative to the front portion of the scooter while remaining attached to the scooter,
wherein the three-dimensional character creates a perspective of riding on or in the three-dimensional character for the user on the deck.

23. The scooter of claim 22, further comprising
a linkage that movably attaches the three-dimensional character to the front portion; and
a wheel connected to the front portion of the scooter and to the mechanical linkage for moving the scooter,
wherein rotation of the wheel is configured to move the mechanical linkage and the three-dimensional character relative to the front portion of the scooter.

24. The scooter of claim 22, further comprising a motor that movably attaches the three-dimensional character to the front portion.

25. The scooter of claim 22, wherein the three-dimensional character is removably attached to the front portion.

26. The scooter of claim 22, further comprising:
a right front wheel connected to a right corner of the front portion;
a left front wheel connected to a left corner of the front portion; and
a rear wheel connected to a center of a rear portion of the deck.

27. The scooter of claim 26, further comprising a rear fender brake disposed above the rear wheel and attached to the rear portion of the deck and configured to deflect relative to the deck and contact an outer surface of the rear wheel.

28. The scooter of claim 27, further comprising a character item attached to the rear fender brake that corresponds to the three-dimensional character disposed on the front portion of the scooter.

29. The scooter of claim 26, wherein the deck is configured to fold about the deck connector into a folded position at which the rear wheel is proximate to the steering column.

30. The scooter of claim 22, wherein the steering column comprises:
a lower steering column attached to and extending vertically from the deck connector; and
an upper steering column attached to the lower steering column with a clamp that allows the upper steering column to extend or retract relative to the lower steering column.

31. A scooter comprising:
a deck for a user to stand on;
a deck connector connected to the deck forward of where the user stands;
a steering column attached to and extending vertically from the deck connector for the user to steer the scooter;
a front portion connected to the deck connector forward of the steering column; and
a three-dimensional character connected to and projecting forwardly from the front portion at a position forward of the steering column, the three-dimensional character comprising a poseable element configured to move from a first position to a second position,
wherein the three-dimensional character creates a perspective of riding on or in the three-dimensional character for the user on the deck.

32. The scooter of claim 31, wherein an expression of the character is changeable by moving the posable element from the first position to the second position.

33. The scooter of claim 31, further comprising:
a right front wheel connected to a right corner of the front portion;
a left front wheel connected to a left corner of the front portion; and
a rear wheel connected to a center of a rear portion of the deck.

34. The scooter of claim 33, further comprising a rear fender brake disposed above the rear wheel and attached to the rear portion of the deck and configured to deflect relative to the deck and contact an outer surface of the rear wheel.

35. The scooter of claim 34, further comprising a character item attached to the rear fender brake that corresponds to the three-dimensional character disposed on the front portion of the scooter.

36. The scooter of claim 31, wherein the steering column comprises:
a lower steering column attached to and extending vertically from the deck connector; and
an upper steering column attached to the lower steering column with a clamp that allows the upper steering column to extend or retract relative to the lower steering column.

37. A scooter comprising:
a deck for a user to stand on, the deck including a rear portion;
a deck connector connected to the deck forward of where the user stands;
a lower steering column connected to and extending upwardly from the deck connector;
an upper steering column having an upper end and a lower end, the lower end attached to the lower steering column with a clamp that allows the upper steering column to extend or retract relative to the lower steering column;
a front portion connected to the deck connector forward relative to the lower steering column and the upper steering column;
a right front wheel connected to a right corner of the front portion;
a left front wheel connected to a left corner of the front portion;
a rear wheel connected to a center of the rear portion of the deck;
a handlebar attached to the upper end of the upper steering column;
a rear fender brake disposed above the rear wheel and attached to the rear portion of the deck and configured to deflect relative to the deck and contact an outer surface of the rear wheel; and
a three-dimensional character disposed on and projecting forwardly from the front portion of the scooter creating a perspective of riding on or in the three-dimensional character for the user on the deck.

38. The scooter of claim 37 further comprising a character item attached to the rear fender brake that corresponds to the three-dimensional character disposed on the front portion of the scooter.

39. The scooter of claim 37 further comprising one or more grips attached to the handlebar.

40. The scooter of claim 37, wherein the deck is configured to fold about the deck connector into a folded position at which the rear wheel is proximate to the lower steering column.
